(19) United States
(12) Patent Application Publication
(10) Pub. No.: US 2026/0276316 A1
(43) Pub. Date: Sep. 17, 2026

(54) Cooling element

(71) Applicant: Thermal Channel Technologies Oy, Oulu (FI)

(72) Inventors: Vesa Pentikäinen, Oulu (FI); Kimmo Jokelainen, Oulu (FI)

(21) Appl. No.: 19/166,053

(22) PCT Filed: Mar. 15, 2024
(86) PCT No.: PCT/FI2024/050117

§ 371 Date: Sep. 17, 2025

(30) Foreign Application Priority Data
Mar. 17, 2023 (FI) 20235316

(51) Int. Cl. F28D 15/02; F28D 21/00

(52) U.S. Cl. CPC F28D 15/0275; F28D 2021/0028; F28F 2255/00

(57) ABSTRACT

According to an example aspect of the present invention, there is provided a cooling element comprising a profile comprising a fitting end, a sleeve having a leading edge and a trailing edge, wherein an inner diameter of the sleeve is greater at the leading edge than at the trailing edge, and a base comprising a collar defining an aperture, wherein the fitting end of the profile is arranged around the collar, and the sleeve is arranged around the fitting end of the profile and apply radial force thereto.

### FIELD

The present invention relates to a kit for forming a heat pipe to a receiving structure, a cooling element comprising the kit, a heat transfer system and a method for forming a heat pipe to a receiving structure.

### BACKGROUND

The cooling of electric components, such as microprocessors, LEDs, IGBT modules, etc., is conventionally based on attaching a cooling element to physical and thermally conducting connection to the component. A typical such cooling element comprises a heat-transfer device, such as a heat pipe, to transfer heat between two solid interfaces.

Heat pipes of the cooling element are typically joined to a base by mechanical press fitting, gluing, soldering, brazing or welding or a thread connection. Joining by soldering or welding is difficult, because it requires controlling of a temperature and flow of a connecting alloy to avoid damaging the heat pipes and providing a permanent tight bond between the joined parts. The thread connection requires complex machining of the heat pipe and the base. A poor joint hinders the operation of the cooling element and is difficult to fix.

Therefore, there remains a need to further develop the joining of the heat pipes to the base without excessively increasing the complexity of the heat transfer system or at least to provide the public with a useful alternative.

### SUMMARY

An object of the present embodiments is to mitigate at least some of the above-mentioned problems. An object of the present embodiments is to provide a reliable, close-fitting and inexpensive joint between a profile and a base of a cooling element.

According to a first aspect of the present invention, there is provided a cooling element comprising:
a profile comprising a fitting end, and
a sleeve having a leading edge and a trailing edge, wherein an inner diameter of the sleeve is greater at the leading edge than at the trailing edge, and
a base comprising a collar defining an aperture,
   wherein the fitting end of the profile is arranged around the collar, and the sleeve is arranged around the fitting end of the profile and apply radial force thereto.

Significant benefits are gained with aid of the present cooling element. It provides a reliable, close-fitting and inexpensive joint between a profile and a base. Thus, soldering requiring a temperature control or complex thread connections can be avoided.

One or more embodiments may comprise one or more features from the following itemized list:
the fitting end comprises an enlarged section, a narrow section connected to the enlarged section
the fitting end comprises an optional transition section between the enlarged section and the narrow section
the greatest nominal outer diameter of the enlarged section is greater than a nominal outer diameter of the narrow section
the sleeve is configured to move along the narrow section without plastic deformation
the sleeve is configured to cause plastic deformation to the enlarged section, when the sleeve is moved along the enlarged section
an inner nominal diameter of the trailing edge of the sleeve is smaller than the greatest nominal outer diameter of the enlarged section
an inner nominal diameter of the leading edge of the sleeve is greater than the nominal outer diameter of the enlarged section
an inner nominal diameter of the trailing edge of the sleeve is greater than a nominal outer diameter of the narrow section

According to a second aspect of the present invention, there is provided a heat transfer system comprising the cooling element and a heat source connected to the base.

According to a third aspect of the present invention, there is provided a method for forming a heat pipe structure to a base of a cooling element comprising:
providing a base,
providing a profile comprising a fitting end,
placing the fitting end of the profile against the base,
providing a sleeve having a leading edge and a trailing edge, wherein an inner diameter of the sleeve is greater at the leading edge than at the trailing edge,
arranging the sleeve around the profile, and
moving the sleeve along the profile to surround the fitting end for applying radial force to the fitting end for compressing the fitting end against the base.

### BRIEF DESCRIPTION OF THE DRAWINGS

FIG. 1 illustrates a kit in accordance with at least some embodiments;

FIG. 2 illustrates a kit comprising a sleeve with a beveling in accordance with at least some embodiments;

FIG. 3 illustrates a cooling element in accordance with at least some embodiments;

FIG. 4 illustrates a base comprising a space in accordance with at least some embodiments;

FIG. 5 illustrates a cooling element comprising the base of FIG. 4 in accordance with at least some embodiments;

FIG. 6 illustrates a base comprising a space in accordance with at least some embodiments;

FIG. 7 illustrates a cooling element comprising the base of FIG. 6;

FIG. 8 illustrates a profile and a base for forming a cooling element comprising an angled profile in accordance with at least some embodiments;

FIG. 9 illustrates a profile and a base comprising a space for forming a cooling element comprising an angled profile in accordance with at least some embodiments;

FIG. 10 illustrates a profile and a base comprising a space for forming a cooling element comprising an angled profile in accordance with at least some embodiments; and

FIG. 11 illustrates a cooling element comprising a curved profile in accordance with at least some embodiments.

### EMBODIMENTS

In the present context, “cooling element” refers to a device for cooling of electric or optical components.

In the present context, “profile” refers to a heat-transfer device that employs phase transition to transfer heat between two solid interfaces. A profile can be a thermosiphon, which is a heat pipe where a liquid is returned to the evaporator by gravitational or other accelerational forces. The profile can form a condenser section of a thermosiphon.

In the present context, “heat pipe structure” refers to a structure comprising a profile and a sleeve. The heat pipe structure is a structure in which fluids, and hence also heat, can be transferred.

In the present context, “evaporator” refers to a device used to turn a liquid into a vapour. The evaporator can be a surface evaporator.

In the present context, “enclosed” refers to an element or feature that is integrated to an another element or feature.

In the present context, “integrated” refers to an element or feature that is an integral part of another element or feature such that said elements or features are inseparable. Further, the term refers to an element or feature that is formed from a material of a body.

Connecting a profile, especially a heat pipe, to a receiving structure can be difficult, because it may require complex machining of the parts or controlling of a temperature and flow of a connecting alloy during soldering or welding. Further, the formed joint may not be sufficiently tight for a high performance of a formed assembly. At least some of the present embodiments solve at least some of the above-mentioned problems.

A kit for forming a heat pipe to a receiving structure can comprise:
a profile 110 comprising a fitting end 111, and
a sleeve 130 having a leading edge 131 and a trailing edge 132, wherein an inner diameter of the sleeve 130 is greater at the leading edge 131 than at the trailing edge 132,
   wherein the sleeve 130 is configured to be arranged around the fitting end 111 of the profile 110 and apply radial force thereto.

The sleeve 130 can be thus tapering from trailing edge 132 to the leading edge 131. The kit provides a reliable, close-fitting and inexpensive joint between a profile and a receiving structure. Due to the kit, soldering requiring a temperature control or complex thread connections can be avoided.

The fitting end 111 can comprise:
an enlarged section 113,
a narrow section 115 connected to the enlarged section 113, and
an optional transition section 114 between the enlarged section 113 and the narrow section 115,
   wherein the greatest nominal outer diameter of the enlarged section 113 is greater than a nominal outer diameter of the narrow section 115. The fitting end provides a reliable attachment of the profile to the receiving structure. The enlarged section enables forming a greater joint between the profile and the receiving structure, which in turn enhanced function of a cooling element, when the kit is used in the cooling element.

The enlarged section 113 can be formed to the profile 110 during producing of the profile 110. Alternatively, the enlarged section 113 can be formed after producing of the profile 110.

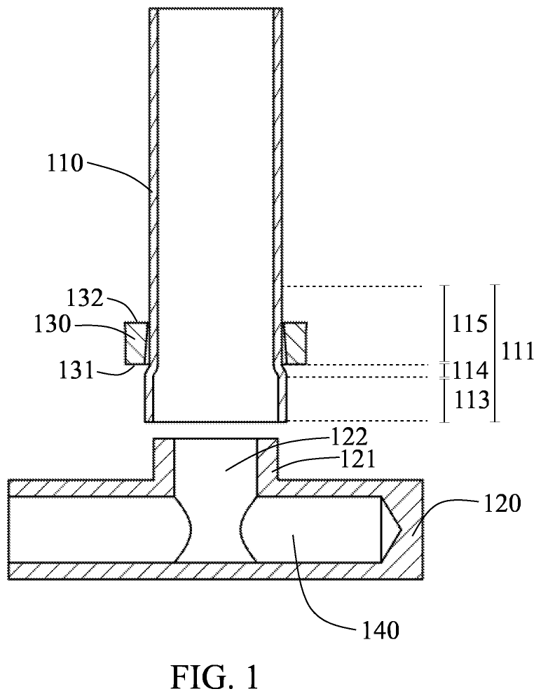

FIG. 1 illustrates a kit. The kit comprises a profile 110 and a sleeve 130. The profile 110 comprises a fitting end 111. The fitting end 111 comprises an enlarged section 113, a narrow section 115 and a transition section 114 between the enlarged section 113 and the narrow section 115. The sleeve 130 has a leading edge 131 and a trailing edge 132. An inner diameter of the sleeve 130 is greater at the leading edge 131 than at the trailing edge 132.

An outer nominal diameter of the transition section 114 can be greater than an outer nominal diameter of the narrow section 115, but smaller than an outer nominal diameter of the enlarged section. The outer nominal diameter of the transition section 114 can decrease towards the narrow section 115. In other words, the transition section can be tapered.

Alternatively, the fitting end 111 can comprise a shoulder (not illustrated) between the enlarged section 113 and the narrow section 115. Then, the fitting end 111 may not comprise the above-described transition section, but the narrow section 115 may be directly connected to the enlarged section.

The nominal outer diameter of the enlarged section 113 can be 1 to 50%, preferably 5 to 20%, greater than the nominal outer diameter of the narrow section 115. This enables forming a greater joint between the profile and the receiving structure, which in turn enhanced function of a cooling element 100, when the kit is used in the cooling element 100.

The sleeve 130 can be configured to move along the narrow section 115 without plastic deformation. Thus, the sleeve is easy to move along the narrow section and it does not damage the narrow section when moved along it.

The sleeve 130 can be configured to cause plastic deformation to the enlarged section 113, when the sleeve 130 is moved along the enlarged section 113. Thus, the sleeve can be pressed around the fitting end so that the fitting end can be tightly and reliably connected to the receiving structure.

An inner nominal diameter of the trailing edge 132 of the sleeve 130 can be smaller than the greatest nominal outer diameter of the enlarged section 113, as illustrated in FIG. 1. Thus, the sleeve is configured to apply radial force to the enlarged section 113, when the sleeve is arranged around the enlarged section 113.

An inner nominal diameter of the leading edge 131 of the sleeve 130 can be greater than the nominal outer diameter of the enlarged section 113, as illustrated in FIG. 1. This makes sliding of the sleeve around the enlarged section easier.

An inner nominal diameter of the trailing edge 132 of the sleeve 130 can be greater than a nominal outer diameter of the narrow section 115, as illustrated in FIG. 1. Thus, the sleeve is easy to move along the narrow section and it does not damage the narrow section when moved along it.

The sleeve 130 can further comprise a bevel or a rounding after the trailing edge 132. Then, the sleeve can be placed around the profile without any difficulty, because the sleeve can be placed around the profile either the leading edge 131 or the trailing edge 132 ahead.

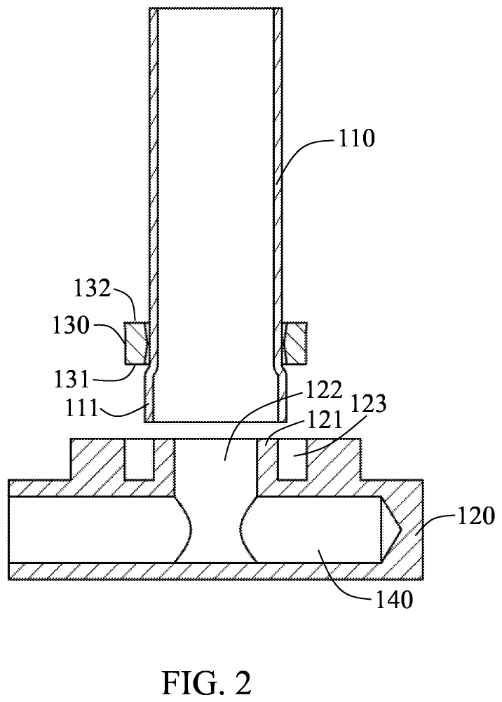

FIG. 2 illustrates a kit comprising a sleeve 130 with a bevel. The sleeve comprises a leading edge 131, a trailing edge 132 and a bevel formed after the trailing edge. The sleeve 130 has the smallest nominal inner diameter at the trailing edge. A nominal inner diameter of the sleeve is substantially same at the leading edge 131 and the beveling. The kit further comprises a profile.

The profile 110 is preferably made from a thermally conducting material, such as aluminium or an aluminium alloy. A cross-section of the profile 110 can be circular or any suitable shape.

The profile 110 can be used as a heat pipe. The profile 110 can have an enclosed volume, in which a heat transferring fluid is arranged to act. The heat transferring fluid is preferably a saturated vapour with little or no impurities.

According to an embodiment, a cooling element 100 comprises:
a kit as described above, and
a base 120 comprising a collar 121 defining an aperture 122,
   wherein a fitting end 111 of a profile 110 is arranged around the collar 121, and the sleeve 130 is arranged around the fitting end 111 of the profile 110 and apply radial force thereto.

The kit provides a reliable, close-fitting and inexpensive joint between the profile and the base of the cooling element.

By “the profile is arranged around the collar”, it is meant that the collar can be at least partially inside the profile. Thus, the profile can enclose at least partially the collar. Then, an inner surface of the profile and an outer surface of the collar can be in the contact.

By “the sleeve is arranged around the fitting end”, it is meant that the fitting end can be at least partially inside the sleeve. Thus, the sleeve can enclose at least partially the fitting end. Then, an inner surface of the sleeve and an outer surface of the fitting end can be in the contact.

According to an embodiment, the base 120 encloses an evaporator 140, which is in fluid connection with the profile 110 via the aperture 122. In other words, the evaporator 140 is an integral part of the base 120. This means that the evaporator 140 cannot be separated from the base 120. The evaporator 140 is formed as a cavity in the basic material of the base 120. The integration of the evaporator 140 to the base 120 is achieved by machining out the channel into the base 120 after producing the base 120. Alternatively, the evaporator 140 can be produced during extrusion or casting of the base 120.

The evaporator 140 can have a width in the first dimension X and a height in a second dimension Y. The width is, at least according to some embodiments, considerably larger than the height making the evaporator generally flat. The purpose of the flat shape is to collect heat from a wider area to the profile and distribute the heat across the second dimension Y. Such an effect is particularly useful in spreading and distributing heat from a hot spot or a small area heat source to a wide surface area or to a large volume. The evaporator can have an enclosed volume, in which a heat transferring fluid is arranged to act.

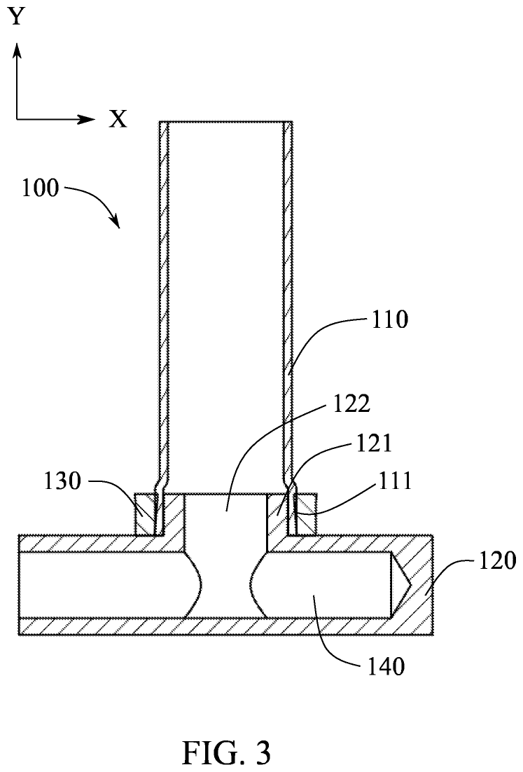

FIG. 3 illustrates a cooling element 100. The cooling element comprises a kit comprising a profile 110 and a sleeve 130. The profile 110 comprises a fitting end 111. The fitting end 111 comprises an enlarged section 113, a narrow section 115 and a transition section 114 between the enlarged section 113 and the narrow section 115. The sleeve 130 has a leading edge 131 and a trailing edge 132. An inner diameter of the sleeve 130 is greater at the leading edge 131 than at the trailing edge 132. The cooling element 100 further comprises a base 120. The base 120 encloses an evaporator 140.

According to an embodiment, the base 120 comprises a space 123 around the collar 121, and the fitting end 111 and the sleeve 130 are arranged in the space 123. The space allows arranging the fitting end 111 and the sleeve 130 around the collar 121.

The space 123 can be formed in the base 120 during producing the base 123. So, the space 123 can be produced during casting of the base 120. Alternatively, the space 123 can be formed to the base 120 after producing the base 120. The space 123 can be formed for example, by machining.

The space 123 can extend from the collar 121 across the width of the base 120 in the first dimension X, as illustrated in FIG. 3. This enables arranging of the fitting ends and sleeves with varying wall thicknesses around the collar.

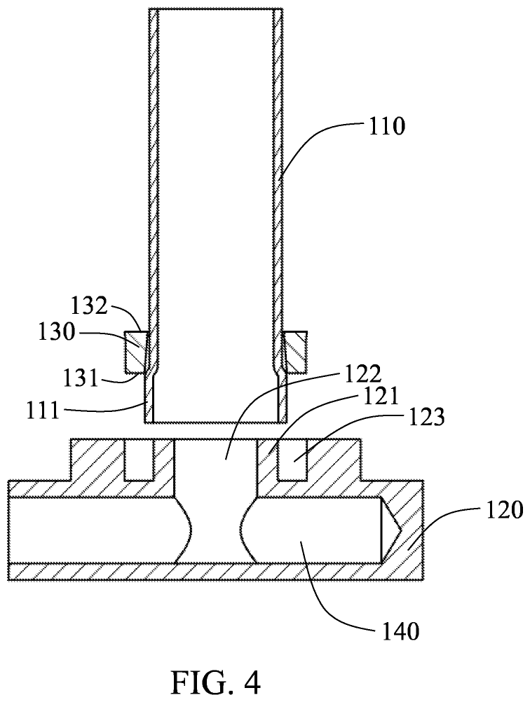

Alternatively, the space 123 can be integrated in the base 120 and the space 123 can be open at least one of its sides for receiving the fitting end 111. Then, the space 123 is surrounded by the collar 121 and a basic material of the base 123, as illustrated in FIGS. 4, 5, 6 and 7. Thus, the fitting end 111 and the sleeve 130 can be arranged tightly in the base between the collar 121 and the basic material of the base 123.

FIG. 4 illustrates a base 120 comprising a space 123. The base 120 further comprises a collar. The space 123 is enclosed by the collar 121 and a basic material of the base 120. A fitting end 111 of a profile 110 and a sleeve 130 are configured to be arranged in the space 123.

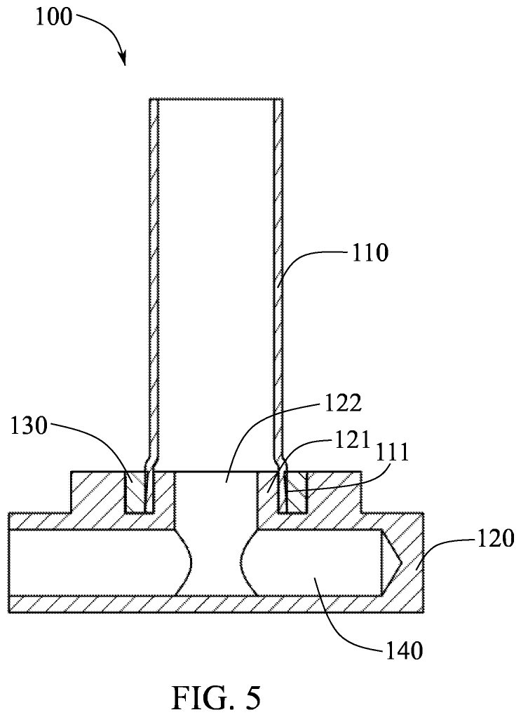

FIG. 5 illustrates a cooling element 100 comprising the base 120 of FIG. 4. The fitting end 111 and the sleeve 130 are arranged in the space 123. So, the collar 121 and the basic material of the base 123 enclose the fitting end 111 and the sleeve 130

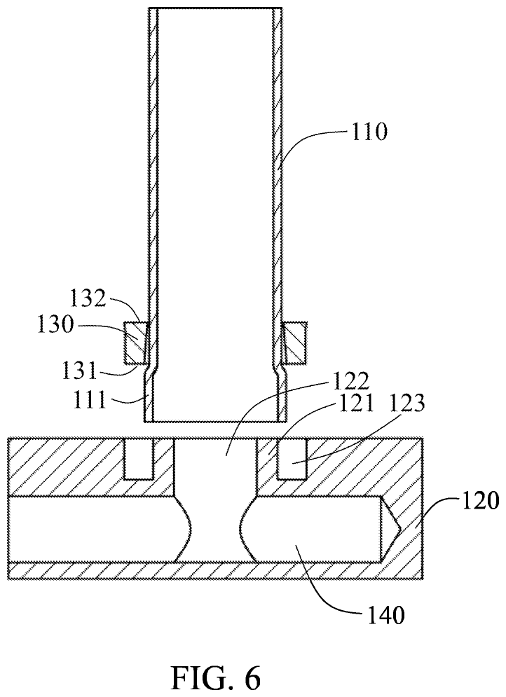

FIG. 6 illustrates a base 120 comprising a space 123. The space 123 is enclosed by a collar 121 and a basic material of the base 120. A fitting end 111 of a profile 110 and a sleeve 130 are configured to be arranged in the space 123.

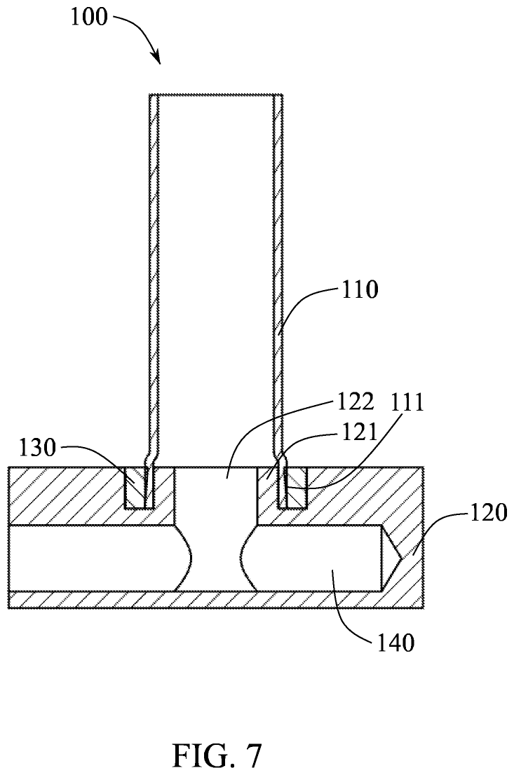

FIG. 7 illustrates a cooling element 100 comprising the base 120 of FIG. 6. The fitting end 111 and the sleeve 130 is arranged in the space 123. So, the collar 121 and the basic material of the base 123 enclose the fitting end 111 and the sleeve 130.

According to an embodiment, yield strength of the collar 121 and the sleeve 130 is greater than yield strength of the enlarged section 113. Thus, the collar can withstand the radial force applied by the sleeve without deformation, but the sleeve can cause plastic deformation to the enlarged section when the sleeve is moved along the enlarged section. This enables of forming a tight connection between the sleeve and enlarged section. In addition, arranging the sleeve around the enlarged section and the collar does not change the shape of the collar. Therefore, it does not affect the operation of the cooling element 100.

According to an embodiment, the base 120 is configured to extend in a first dimension X and the profile 110 is configured to extend in a second dimension Y, which second dimension Y is angled in respect to the first dimension X. By adjusting the angle, the heat can be directed in the desired direction.

According to an embodiment, the angle between the first dimension X and the second dimension Y is 5 to 45 degrees, preferably 5 to 25 degrees. For example, the angle is 5, 10, 15, 20 or 25 degrees.

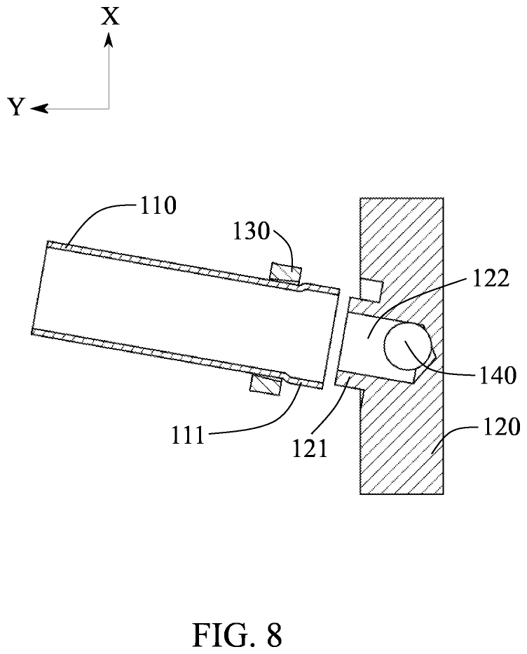

FIG. 8 illustrates a profile 110 and a base 120 for forming a cooling element comprising an angled profile 110. The profile 110 comprises a sleeve 130 around the profile 110. A base 120 comprises a collar 121. The collar 121 extends in a second dimension Y, which is angled in respect to a first dimension X. The space 123 extends from the collar 121 across the width of the base 120 in the first dimension X. The profile 110 and the sleeve 130 are configured to be arranged around the collar 121 for forming a cooling element comprising an angled profile 110.

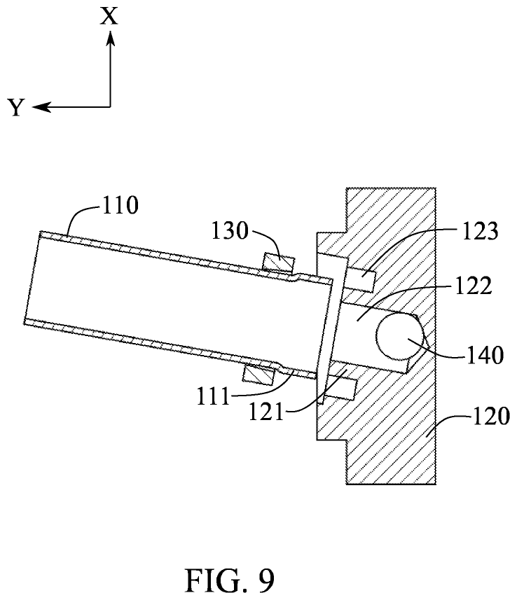

FIG. 9 illustrates a profile 110 and a base 120 comprising a space 123 for forming a cooling element comprising an angled profile 110. The profile 110 comprises a sleeve 130 around the profile 110 and a base 120 comprises a collar 121. The collar 121 extends in a second dimension Y, which is angled in respect to a first dimension X. The space 123 is enclosed by a collar 121 and a basic material of the base 120. The profile 110 and the sleeve 130 are configured to be arranged around the collar 121 for forming a cooling element comprising an angled profile 110.

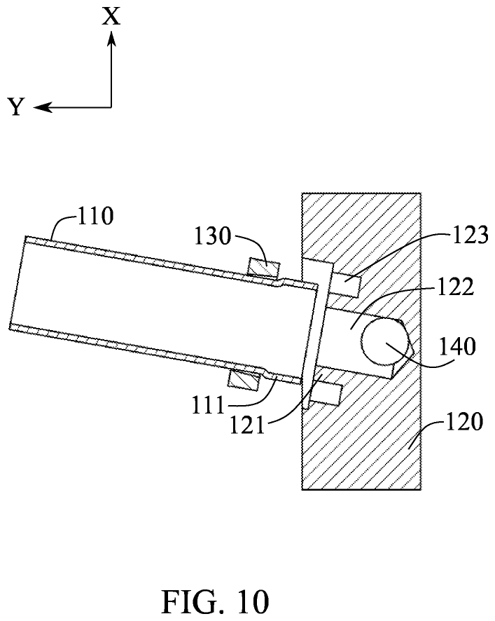

FIG. 10 illustrates a profile 110 and a base 120 comprising a space 123 for forming a cooling element comprising an angled profile 110. The profile 110 comprises a sleeve 130 around the profile 110 and a base 120 comprises a collar 121. The collar 121 extends in a second dimension Y, which is angled in respect to a first dimension X. The space 123 is enclosed by a collar 121 and a basic material of the base 120. The profile 110 and the sleeve 130 are configured to be arranged around the collar 121 for forming a cooling element comprising an angled profile 110.

The profile 110 can be curved. This enables more effective use of a space if the space is limited in the first direction X. Then a space in the second direction Y can be used for providing a long enough profile for effective heat transfer. In addition, the sleeve enhances the connection of the curved profile to the base.

A bend angle of the profile 110 can be 5 to 45 degrees, preferably 5 to 25 degrees.

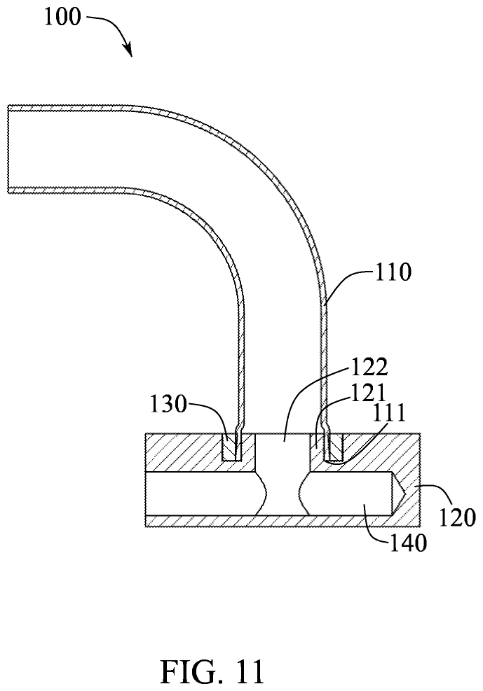

FIG. 11 a cooling element 100 comprising a curved profile 110. The cooling element 100 comprises a base 120 enclosing an evaporator 140. The base further comprises a space. The curved profile 110 comprises a fitting end 111 and a sleeve 130 around the fitting end 111. The fitting end 111 and the sleeve are arranged in the space 123. The evaporator is in fluid contact with the curved profile 110 via an aperture 122.

According to an embodiment, a heat transfer system comprises a cooling element 100 as described above and a heat source connected to a base 120. The heat source can be for example, an electrical or optical component.

According to an embodiment, a method for forming a heat pipe to a receiving structure comprising:
providing a receiving structure,
providing a profile 110 comprising a fitting end 111,
placing the fitting end 111 of the profile 110 against the receiving structure,
providing a sleeve 130 having a leading edge 131 and a trailing edge 132, wherein an inner diameter of the sleeve 130 is greater at the leading edge 131 than at the trailing edge 132,
arranging the sleeve 130 around the profile 110, and
moving the sleeve 130 along the profile 110 to surround the fitting end 111 for applying radial force to the fitting end 111 for compressing the fitting end 111 against the receiving structure.

The method provides a reliable, close-fitting and inexpensive joint between a profile and a receiving structure. Due to the kit, soldering requiring a temperature control or complex thread connections can be avoided.

The receiving structure can be a base 120.

The fitting can be performed with the kit as described above.

As described above, the fitting end 111 can comprise an enlarged section 113, a narrow section 115 connected to the enlarged section 113, and an optional transition section 114 between the enlarged section 113 and the narrow section 115. The greatest nominal outer diameter of the enlarged section 113 is greater than a nominal outer diameter of the narrow section 115. Then the method can comprise moving the sleeve 130 around the narrow section 115 before moving the sleeve 130 around the fitting end 111. Thus, the sleeve can be slipped through an opposite second end to surround the profile and then moved around the narrow section before the sleeve is arranged to surround the fitting end.

According an embodiment, the method further comprises moving the sleeve 130 along the narrow section 115 without plastic deformation. The sleeve can be moved along the narrow section without any difficulty and damage to the narrow section.

According to an embodiment, the method further comprises causing plastic deformation to the fitting end 111, when the sleeve 130 is moved along the enlarged section 113. Thus, the fitting end can be tightly connected to the receiving structure. The formed joint is close-fitting and does not leak. This in turn provides better performance of a cooling element 100, when the method is used for attaching a profile to a base of the cooling element 100.

According to an embodiment, the receiving structure is a male receiving structure.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the invention.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### REFERENCE SIGNS LIST

100 cooling element
110 profile
111 fitting end
112 second end
113 enlarged section
114 transition section
115 narrow section
120 base
121 collar
122 aperture
123 space
130 sleeve
131 leading edge
132 trailing edge
140 evaporator

1. A cooling element comprising:
a profile comprising a fitting end.
a sleeve having a leading edge and a trailing edge, wherein an inner diameter of the sleeve is greater at the leading edge than at the trailing edge, and
a base comprising a collar defining an aperture,
wherein the fitting end of the profile is arranged around the collar, and the sleeve is arranged around the fitting end of the profile and apply radial force thereto.

2. The cooling element of claim 1, wherein the fitting end comprises:
an enlarged section,
a narrow section connected to the enlarged section, and
an optional transition section between the enlarged section and the narrow section,
wherein the greatest nominal outer diameter of the enlarged section is greater than a nominal outer diameter of the narrow section.

3. The cooling element of claim 2, wherein the sleeve is configured to move along the narrow section without plastic deformation.

4. The cooling element of claim 2, wherein the sleeve is configured to cause plastic deformation to the enlarged section, when the sleeve is moved along the enlarged section.

5. The cooling element of claim 2, wherein an inner nominal diameter of the trailing edge of the sleeve is smaller than the greatest nominal outer diameter of the enlarged section.

6. The cooling element of claim 2, wherein an inner nominal diameter of the leading edge of the sleeve is greater than the nominal outer diameter of the enlarged section.

7. The cooling element of claim 2, wherein an inner nominal diameter of the trailing edge of the sleeve is greater than a nominal outer diameter of the narrow section.

8. The cooling element of claim 1, wherein the base comprises a space around the collar, and the fitting end and the sleeve are arranged in the space.

9. The cooling element of claim 1, wherein yield strength of the collar and the sleeve is greater than yield strength of enlarged section.

10. The cooling element of claim 1, wherein the base encloses an evaporator (140), which is in fluid connection with the profile via the aperture.

11. The cooling element of claim 1, wherein the base is configured to extend in a first dimension (X) and the profile is configured to extend in a second dimension (Y), which second dimension (Y) is angled in respect to the first dimension (X).

12. The cooling element of claim 11, wherein the angle between the first dimension (X) and the second dimension (Y) is 5 to 45 degrees, preferably 5 to 25 degrees.

13. A heat transfer system comprising a cooling element of claim 1 and a heat source connected to a base.

14. A method for forming a heat pipe structure to a base of a cooling element comprising:
providing the base,
providing a profile comprising a fitting end,
placing the fitting end of the profile against the base,
providing a sleeve having a leading edge and a trailing edge, wherein an inner diameter of the sleeve is greater at the leading edge than at the trailing edge,
arranging the sleeve around the profile, and
moving the sleeve along the profile to surround the fitting end for applying radial force to the fitting end for compressing the fitting end against the base.

15. The method of claim 14, wherein the fitting end comprises:
an enlarged section,
a narrow section connected to the enlarged section, and
an optional transition section between the enlarged section and the narrow section,
wherein the greatest nominal outer diameter of the enlarged section is greater than a nominal outer diameter of the narrow section.

16. The method of claim 15, further comprising moving the sleeve around the narrow section before moving the sleeve around the fitting end.

17. The method of claim 16, further comprising moving the sleeve along the narrow section without plastic deformation.

18. The method of claim 16, further comprising causing plastic deformation to the fitting end, when the sleeve is moved along the enlarged section.

19. The method of claim 14, wherein the base is a male receiving structure.
